(19) United States
(12) Patent Application Publication
(10) Pub. No.: US 2009/0237530 A1
(43) Pub. Date: Sep. 24, 2009

(54) METHODS AND APPARATUSES FOR SHARPENING IMAGES

(76) Inventor: Ilia Ovsiannikov, Studio City, CA (US)

Correspondence Address: DICKSTEIN SHAPIRO LLP, 1825 EYE STREET NW, Washington, DC, 20006-5403, US

(21) Appl. No.: 12/052,305

(22) Filed: Mar. 20, 2008

(51) Int. Cl. H04N 9/68; H04N 3/14

(52) U.S. Cl. 348/234; 382/274; 348/272; 348/E09.053; 348/E03.022

(57) ABSTRACT

Methods and apparatuses for sharpening imaging pixel signals. Embodiments provide methods of sharpening that preserves the pixel's saturation and apparatuses therefor. In essence, rather than changing only the pixels' luminance, the effective exposure of the pixel is changed.

### FIELD OF THE INVENTION

The embodiments described herein relate generally to the field of digital image processing, and more specifically to methods and apparatuses for sharpening images through digital image processing.

### BACKGROUND OF THE INVENTION

Solid state imaging devices, including charge coupled devices (CCD), complementary metal oxide semiconductor (CMOS) imaging devices, and others, have been used in photo imaging applications. A solid state imaging device circuit includes a focal plane array of pixel cells or pixels as an image sensor, each cell including a photosensor, which may be a photogate, photoconductor, a photodiode, or other photosensor having a doped region for accumulating photo-generated charge. CMOS imaging devices of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, assigned to Micron Technology, Inc.

Imaging devices, e.g., cameras, are often configured to apply some level of image sharpening as a part of their default image processing. Sharpening is typically applied to the luminance component of an image signal, while the chrominance component remains unchanged. This type of sharpening can produce visible artifacts diminishing the quality of the resultant image. Specifically, pixels located on the darker side of an edge and having some coloration become more colored.

In many instances, it would be desirable to have a method and apparatus for image sharpening that does not produce the artifacts as described above to provide improved image quality.

### BRIEF DESCRIPTION OF THE DRAWINGS

FIG. 1 is a block diagram of a portion of a pixel array.

FIG. 2 is a flow chart illustrating a method for sharpening images according to an embodiment.

FIG. 3 is a block diagram of a hardware implemented embodiment of sharpening in accordance with an embodiment described herein.

FIG. 4 is a block diagram of an imaging device according to an embodiment.

FIG. 5 is a block diagram of a processor system, e.g., a digital camera, employing the imaging device of FIG. 4.

### DETAILED DESCRIPTION OF THE INVENTION

In the following detailed description, reference is made to the accompanying drawings which form a part hereof, and in which is shown by way of illustration specific embodiments that may be practiced. These embodiments are described in sufficient detail to enable those of ordinary skill in the art to make and use them, and it is to be understood that structural, logical, or procedural changes may be made to the specific embodiments disclosed.

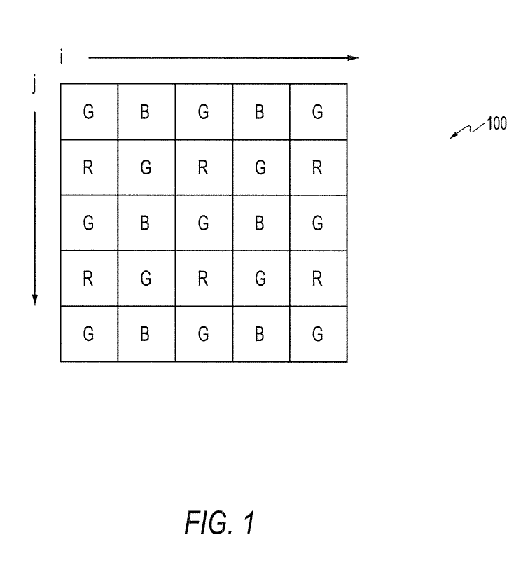

Raw imaging data from an imaging device that uses a red, green, blue (RGB) Bayer pattern color filter array (CFA) consists of a mosaic of red, green, and blue pixel values and is often referred to as Bayer RGB data. FIG. 1 shows a portion of a pixel array 100 consisting of pixels associated with a Bayer pattern color filter array and organized in rows, i, and columns, j.

The luminance and chrominance components of the original image can be defined as: Yᵢⱼ, Uᵢⱼ and Vᵢⱼ, where i is the row in which the pixel is located and j is the column in which the pixel is located. These components may be linear or gamma corrected. The sharpness correction to be applied to each pixel in the original image can be defined as ΔYᵢⱼ. The resultant sharpened components can be defined as: Y_{S ij}, U_{S ij} and V_{S ij}. Sharpening is typically applied as follows:

Y_{S ij}=Yᵢⱼ+ΔYᵢⱼ (1)

U_{S ij}=Uᵢⱼ (2)

V_{S ij}=Vᵢⱼ (3)

If a pixel on the darker side of an edge is considered, the sharpening according to the above traditional method would further reduce the luminance, while preserving the color-difference chrominance components (Uᵢⱼ and Vᵢⱼ). When the color-difference components are non-zero (i.e., the pixel has some coloration), the sharpening may effectively increase the pixel's saturation. For example, when a pixel with Y, U, V components of {50, 10, 10} is sharpened by ΔY of −50, the resulting sharpened components Ys, Us, Vs become {0, 10, 10}. Such a pixel has zero luminance and only chrominance present. If, for purposes of this example, saturation in YUV space is defined as S_{U}=|U|/(Y+|U|) and S_{V}=|V|/(Y+|V|), the saturation of the pixel has increased from 17% to 100%.

To avoid such an undesirable effect, embodiments herein provide methods of image sharpening that includes adjusting the pixel's saturation and apparatuses therefor. In essence, rather than changing only the pixels' luminance, the effective exposure of the pixel is also changed.

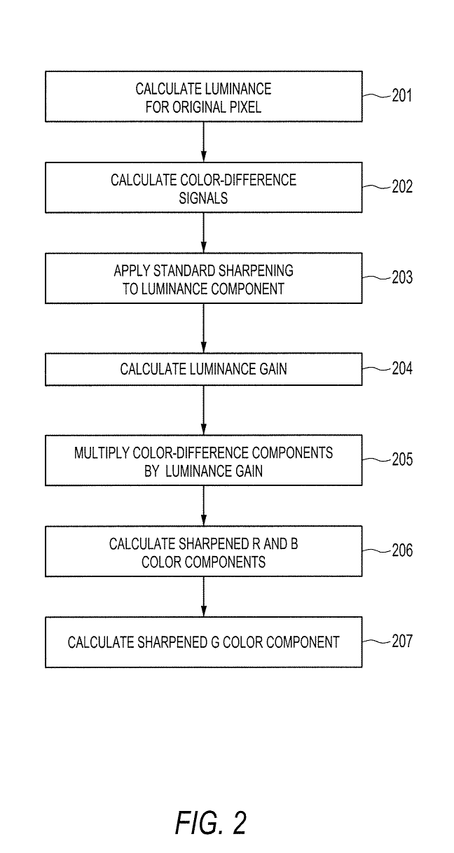

FIG. 2 is a flow chart illustrating a method of sharpening according to an embodiment now described. For ease of explanation, the original image will be described in RGB (red green blue) color space. However, it should be noted that the original and resultant images may be described in other color spaces.

The method of FIG. 2 is explained with reference to a single pixel. It should be understood that the method will be carried out on more than one pixel in an image as desired to obtain a sharpened image. Further, although the method is described as having a particular order, the order depicted is one example and the steps can be carried out in a different order, if desired.

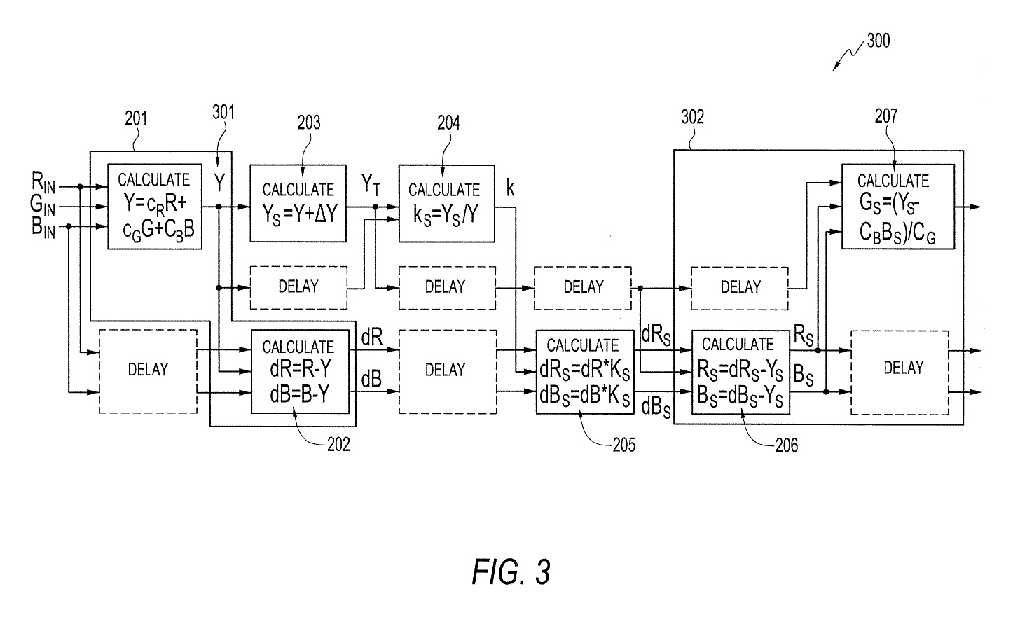

FIG. 3 illustrates an embodiment of a sharpening processor 300 for carrying out the sharpening methods. The processor 300 may be a camera processor or an image processor associated with image capture and may be a programmed processor, a hard-wired processor, or a combined programmed and hard-wired processor. The methods described herein can also be carried out using a software program running on a processor.

Referring to FIG. 2, in step 201, the luminance for the original pixel signal is calculated. Luminance can be calculated using a formula appropriate for the color space and encoding used. For example, luminance Y data represented in standard RGB color space after demosaicing and before gamma correction can be calculated using one of the following formulas:

Y=c_{R}*R+c_{G}*G+c_{B}*B (where, for example, c_{R}=0.2126, c_{B}=0.0722 and c_{G}=0.7152); (4)

or, for example, if accuracy is sacrificed in favor of simplicity of calculation:

Y=(R+2*G+B)/4 (5)

In step 202, color-difference signals dR, dB are calculated for the original pixel signal as follows:

dR=R−Y (6)

dB=B−Y (7)

If the input is encoded in YUV colorspace, the YUV data may be supplied directly, and the shaded steps 201, 202 of box 301 may be omitted. That is, luminance Y, red and blue color-differences do not need to be calculated because they are directly inputted.

In step 203, the luminance component of the original pixel signal is subjected to traditional sharpening correction as follows to determine a sharpened luminance component, Y_{S}:

Y_{S}=Y+ΔY (8)

In step 204 the, luminance gain k_{S} for the original pixel signal is calculated as shown in equation (9). The luminance gain k_{S} represents the amount of the pixel's effective over exposure or under exposure.

k_{S}=Y_{S}/Y (9)

In step 205, the color-difference components are multiplied by the effective luminance gain k_{S} to obtain sharpened color difference components, dR_{S}, dR_{S}:

dR_{S}=dR*k_{S} (10)

dB_{S}=dB*k_{S} (11)

In step 206, the resulting sharpened red and blue color components, R_{S} and B_{S}, are reconstructed by plugging in dR_{S}, Y_{S} and dB_{S} into equations (6) and (7) and solving for R and B as follows:

R_{S}=dR_{S}+Y_{S} (12)

B_{S}=dB_{S}+Y_{S} (13)

In step 207, the resulting sharpened green color component G_{S} is reconstructed by plugging in R_{S}, Y_{S} and B_{S} into equation (4) or (5) and solving for G. For example, G_{S} can be calculated as follows:

G_{S}=(Y_{S}−c_{R}*R−c_{B}*B_{S})/c_{G} (where, for example, c_{R}=0.2126, c_{B}=0.0722 and c_{G}=0.7152); or (14)

G_{S}=(4*Y_{S}−R_{S}−B_{S})/2 (15)

If YUV-encoded output data is desired, dR_{S}, dB_{S}, Y_{S} may be directly output, thus steps 206, 207 in box 302 of FIG. 3 may be omitted. That is, R_{S}, G_{S}, B_{S} do not need to be calculated.

In an alternative embodiment, when ΔY is greater than zero, the traditional sharpening method is applied as described above in connection with equations (1), (2) and (3). When ΔY is not greater than zero, the method described above in connection with FIG. 2 is used. In another alternative, U and V components are reduced more aggressively by decreasing k_{S} by a predetermined amount when ΔY is greater than or less than zero to determine a corrected luminance gain k_{S1} (k_{S1}=k_{X}·X, 0≦X≦1).

If desired, the sharpening processor 300 can be configured to carry out additional image correction, such as tonal correction in accordance with co-pending application Ser. No. 11/506,870, filed on Aug. 21, 2006, and assigned to Micron Technology, Inc. In such a case, the sharpened luminance component Y_{S} is calculated (step 203, FIG. 2) before or after a luma (Y_{T}) is calculated as described in application Ser. No. 11/506,870. This can provide additional logic savings.

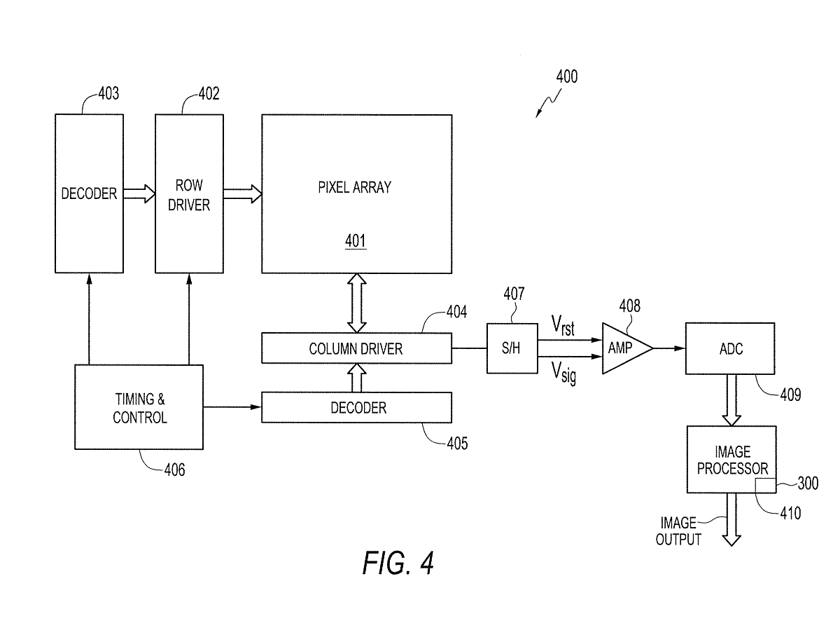

FIG. 4 illustrates a simplified block diagram of an example imaging device 400 for generating the input and output signals, as described above. Pixel array 401 comprises a plurality of pixels arranged in a predetermined number of columns and rows. The row lines are selectively activated by the row driver 402 in response to row address decoder 403 and the column select lines are selectively activated by the column driver 404 in response to column address decoder 405. Thus, a row and column address is provided for each pixel.

The imaging device 400 is operated by a timing and control circuit 406, which controls decoders 403, 405 for selecting the appropriate row and column lines for pixel readout, and row and column driver circuitry 402, 404, which apply driving voltage to the drive transistors of the selected row and column lines. The pixel signals, which typically include a pixel cell reset signal Vrst and a pixel image signal Vsig for each pixel are read by sample and hold circuitry 407 associated with the column driver 404. A differential signal Vrst−Vsig is produced for each pixel, which is amplified by an amplifier 408 and digitized by analog-to-digital converter 409. The analog-to-digital converter 409 converts the analog pixel signals to digital signals in RGB or YUV colorspace, which are fed to an image processor 410 which may perform the FIG. 2 process. As shown in FIG. 4, processor 410 can include sharpening processor 300. Although the processor 410 is illustrated as part of FIG. 4, it should be noted that the processor 410 may or may not be on the same chip as the pixel array 401 and a processor may or may not be located in other portions of the imaging chain. However, it may be desirable to have the processor 410 on the same chip for image collecting purposes.

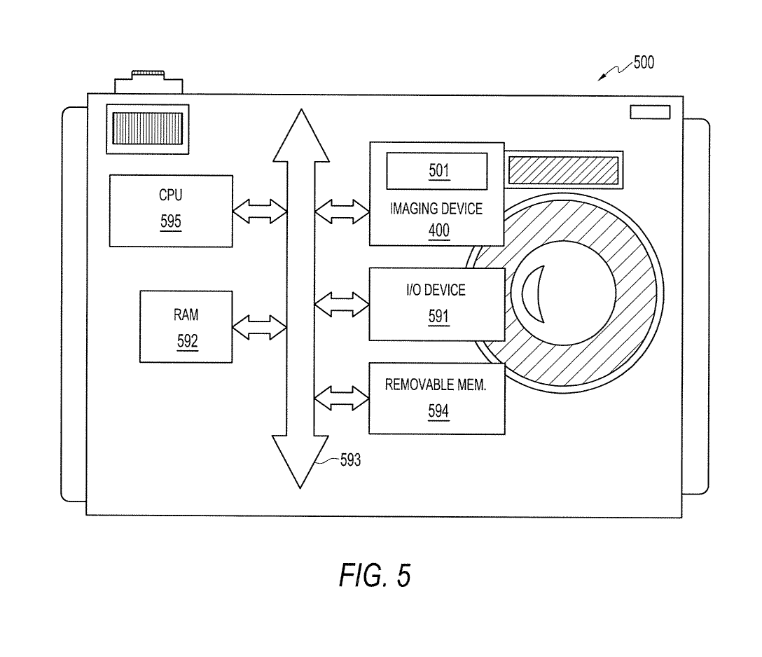

FIG. 5 shows in simplified form a typical processor system 500, for example, in a camera, modified to include an imaging device 400 (FIG. 4) employing a method of image sharpening in accordance with the embodiment described above. The processor system 500 is an example of a system having digital circuits that could include image sensor devices. Without being limiting, such a system could include a digital camera, as shown in FIG. 5, or a computer system, still or video camera system, scanner, machine vision, vehicle navigation, video phone, surveillance system, auto focus system, star tracker system, motion detection system, image stabilization system, and other systems employing an imaging device.

The system 500, for example a digital still or video camera system, generally comprises a central processing unit (CPU) 595, such as a microprocessor which controls camera and one or more image flow functions, that communicates with an input/output (I/O) devices 591 over a bus 593. Imaging device 400 also communicates with the CPU 595 over bus 593. The system 500 also includes random access memory (RAM) 592 and can include removable memory 594, such as flash memory, which also communicate with CPU 595 over the bus 493. Imaging device 400 may be combined with a processor, such as a CPU, digital signal processor, or microprocessor, with or without memory storage on a single integrated circuit or on a different chip than the processor. Although bus 593 is illustrated as a single bus, it may be one or more busses or bridges used to interconnect the system components.

While the embodiments have been described in detail in connection with desired embodiments known at the time, it should be readily understood that the claimed invention is not limited to the disclosed embodiments. Rather, the embodiments can be modified to incorporate any number of variations, alterations, substitutions, or equivalent arrangements not heretofore described. For example, while the embodiments are described in connection with a CMOS imaging sensor, they can be practiced with image data from other types of imaging sensors, for example, CCD imagers and others.

What is claimed as new and desired to be protected by Letters Patent of the United States is:

1. A method of processing signals from an array of imaging pixels, comprising the acts of:
inputting first, second and third color signals;
determining an incident luminance as a function of the input first, second and third color signals;
applying a sharpening correction to the incident luminance to determine a sharpened luminance component; and
applying an algorithm to determine sharpened first, second and third color signals.

2. The method of claim 1, wherein applying an algorithm comprises determining a luminance gain using the sharpened luminance component and the incident luminance;
determining a first color-difference component using the incident luminance and the first color signal;
determining a second color-difference component using the incident luminance and the second color signal;
determining a first sharpened color-difference component using the first color-difference component and the luminance gain; and
determining a second sharpened color-difference component using the second color-difference component and the luminance gain.

3. The method of claim 1, wherein the first, second, and third color signals are red, blue and green signals, respectively.

4. The method of claim 1, wherein the sharpening correction is less than or equal to zero.

5. The method of claim 1, if the sharpening correction is less than zero, further comprising determining a corrected luminance gain by reducing the luminance gain by a predetermined amount.

6. The method of claim 2, wherein the act of determining the luminance gain comprises dividing the sharpened luminance component by the incident luminance.

7. The method of claim 2, wherein the act of determining a first sharpened color-difference component comprises multiplying the first color-difference component by the luminance gain.

8. The method of claim 2, wherein the act of determining a second sharpened color-difference component comprises multiplying the second color-difference component by the luminance gain.

9. The method of claim 1, further comprising performing the act of tonal correction on the first second and third color signals.

10. The method of claim 2, further comprising:
determining a first sharpened color component using the first sharpened color-difference component and sharpened luminance component;
determining a second sharpened color component using the second sharpened color-difference component and sharpened luminance component; and
determining a third sharpening color component using the first and second sharpening color components and the sharpened luminance component.

11. An imaging device comprising:
an input device for capturing incident light and converting incident light into incident first, second and third color signals;
a processor configured for:
determining an incident luminance as a function of the input first, second and third color signals;
applying a sharpening correction to the incident luminance to determine a sharpened luminance component;
determining a luminance gain using the sharpened luminance component and the incident luminance;
determining a first color-difference component using the incident luminance and the first color signal;
determining a second color-difference component using the incident luminance and the second color signal;
determining a first sharpened color-difference component using the first color-difference component and the luminance gain;
determining a second sharpened color-difference component using the second color-difference component and the luminance gain;
determining a first sharpened color component using the first sharpened color-difference component and sharpened luminance component;
determining a second sharpened color component using the second sharpened color-difference component and sharpened luminance component;
determining a third sharpening color component using the first and second sharpening color components and the sharpened luminance component; and
an output device for outputting first, second and third sharpened color components.

12. The imaging device of claim 11, wherein the first, second, and third color signals are red, blue and green signals, respectively.

13. The imaging device of claim 11, wherein the sharpening correction is less than or equal to zero.

14. The imaging device of claim 11, if the sharpening correction is less than zero, further comprising determining a corrected luminance gain by reducing the luminance gain by a predetermined amount.

15. The imaging device of claim 11, wherein determining the luminance gain comprises dividing the sharpened luminance component by the incident luminance.

16. The imaging device of claim 11, wherein determining a first sharpened color-difference component comprises multiplying the first color-difference component by the luminance gain.

17. The imaging device of claim 11, wherein determining a second sharpened color-difference component comprises multiplying the second color-difference component by the luminance gain.

18. The imaging device of claim 11, wherein the processor is configured to further perform tonal correction.

19. A camera device comprising:
a lens structure for imaging a scene;
an input device including a pixel array for capturing incident light received from the lens structure and a circuit for converting the captured incident light for an image pixel into an incident luminance signal, a first color difference and a second color difference; and
a processor configured for:
determining an incident luminance as a function of the input first, second and third color signals;
applying a sharpening correction to the incident luminance to determine a sharpened luminance component;
determining a luminance gain using the sharpened luminance component by the incident luminance;
determining a first color-difference component using the incident luminance and the first color signal;
determining a second color-difference component using the incident luminance and the second color signal;
determining a first sharpened color-difference component using the first color-difference component and the luminance gain; and
determining a second sharpened color-difference component using the second color-difference component and the luminance gain.

20. The camera device of claim 19, wherein the processor is further configured for:
determining a first sharpened color component using the first sharpened color-difference component and sharpened luminance component;
determining a second sharpened color component using the second sharpened color-difference component and sharpened luminance component; and
determining a third sharpening color component using the first and second sharpening color components ant the sharpened luminance component.

21. The camera device of claim 19, wherein the first, second, and third color signals are red, blue and green signals, respectively.

22. The camera device of claim 19, wherein the sharpening correction is less than or equal to zero.

23. The camera device of claim 19, if the sharpening correction is less than zero, further comprising determining a corrected luminance gain by reducing the luminance gain by a predetermined amount.

24. The camera device of claim 19, wherein determining the luminance gain comprises dividing the sharpened luminance component by the incident luminance.

25. The camera device of claim 19, wherein determining a first sharpened color-difference component comprises multiplying the first color-difference component by the luminance gain.

26. The camera device of claim 19, wherein determining a second sharpened color-difference component comprises multiplying the second color-difference component by the luminance gain.
